(19) United States
(12) Patent Application Publication
(10) Pub. No.: US 2015/0149578 A1
(43) Pub. Date: May 28, 2015

(54) STORAGE DEVICE AND METHOD OF DISTRIBUTED PROCESSING OF MULTIMEDIA DATA

(71) Applicant: SAMSUNG ELECTRONICS CO., LTD., Suwon-si (KR)

(72) Inventors: Min-soo KIM, Yongin-si (KR); Seung-won LEE, Hwaseong-si (KR); Won-chang LEE, Seongnam-si (KR); Jong-hun LEE, Suwon-si (KR); Chae-seok IM, Yongin-si (KR)

(73) Assignee: SAMSUNG ELECTRONICS CO., LTD., Suwon-si (KR)

(21) Appl. No.: 14/555,203

(22) Filed: Nov. 26, 2014

(30) Foreign Application Priority Data
Nov. 26, 2013 (KR) 10-2013-0144246

(51) Int. Cl. H04L 29/08

(52) U.S. Cl. CPC H04L 67/1097
USPC 709/213

(57) ABSTRACT

Provided are a storage device and a method of distributed processing of multimedia data. In the method, the storage device stores multimedia data, initiates an interface configured to share data between a host and the storage device, receives a multimedia data request from the host, processes the multimedia data based on the received multimedia data request, and transmits the processed multimedia data to the host through the interface.

### RELATED APPLICATIONS

This application claims priority from Korean Patent Application No. 10-2013-0144246, filed on Nov. 26, 2013, in the Korean Intellectual Property Office, the disclosure of which is incorporated herein in its entirety by reference.

### BACKGROUND

1. Field

Exemplary embodiments relate to storage devices and methods of distributed processing of multimedia data, and more particularly, to storage devices and methods of processing multimedia data based on a multimedia data request received from a host and transmitting the processed multimedia data to the host.

2. Description of the Related Art

A computer includes an input device, an output device, a memory device, and an operation device. The memory device includes a main memory device that temporarily stores instructions for execution and control of operations of the operation device, and an auxiliary memory device that stores operation results and various data. The main memory device is configured to provide a high-speed operation because it is used by a central processing unit (CPU) that is the operation device; and the auxiliary memory device is configured to have a high capacity because it is used to store various data. Therefore, a semiconductor memory device such as read-only memory (ROM) or random-access memory (RAM) is mainly used as the main memory device; and a floppy disk, a hard disk, a magnetic drum, a magnetic tape, an optical disk (e.g., a compact disk (CD)), or a flash memory is used as the auxiliary memory device. The auxiliary memory device has nonvolatile characteristics in order to freely read/write a large amount of data and retain data even when power supply thereto is interrupted. A hard disk drive (HDD), which has long been used as an auxiliary memory device, uses a magnetic disk as a recording medium, and satisfies the above-described characteristics of the auxiliary memory device well.

Various digital electronic products such as PCs, digital cameras, personal digital assistants (PDAs), digital music players, and mobile phones are increasingly used, and most of the digital electronic products use data storage devices. Computers usually use hard disks as data storage devices, but other electronic products usually use semiconductor memory-based storage media due to problems of volume and weight. A solid state drive (SSD) is a high-speed auxiliary memory device that replaces a hard disk. The SSD is similar to the hard disk in terms of application, external shape, and installation method, but is different from the hard disk in terms of internal structure. Unlike the hard disk, the SSD includes a semiconductor memory but not a magnetic disk. Due to these characteristics, the SSD may perform a read/write operation faster than the hard disk. Also, since the SSD has no physically moving components, it operates noiselessly and consumes less power. Due to these characteristics, when the SSD is used in a portable digital electronic product, a battery lifetime thereof may be increased.

In the related art, a host directly accesses multimedia data stored in a storage device such as an auxiliary memory device, the storage device transmits all multimedia data to the host, and a host processor has to process all the multimedia data. For example, while only an intra frame is necessary to perform fast forward, rewind, and thumbnail generation, the storage device transmits all multimedia data to a synchronous dynamic RAM (SDRAM) of the host and the host processor has to decode and process all the multimedia data.

### SUMMARY

Exemplary embodiments include methods of processing multimedia data in a storage device based on a multimedia data request received from a host and transmitting the processed multimedia data to the host.

Exemplary embodiments include storage devices for processing multimedia data based on a multimedia data request received from a host and transmitting the processed multimedia data to the host.

Additional aspects will be set forth in part in the description which follows and, in part, will be apparent from the description, or may be learned by practice of the presented embodiments.

According to an exemplary embodiment, a method of distributed processing of multimedia data by a storage device includes: storing multimedia data; initiating an interface configured to share data between a host and the storage device and receiving a multimedia data request from the host; processing the multimedia data based on the received multimedia data request; and transmitting the processed multimedia data to the host through the interface.

The receiving of the multimedia data request may include receiving at least one of a command and a program executable in the storage device from the host, and the processing of the multimedia data may include processing the multimedia data based on at least one of the received command and the received program.

The processing of the multimedia data may include detecting and extracting an intra frame from the multimedia data, and the transmitting of the multimedia data may include transmitting the extracted intra frame.

The processing of the multimedia data may include: decoding the multimedia data; and detecting a thumbnail frame from the decoded multimedia data and generating a thumbnail, and the transmitting of the multimedia data may include transmitting the generated thumbnail.

The processing of the multimedia data may include extracting a data descriptor from the multimedia data, and the transmitting of the multimedia data may include transmitting the extracted data descriptor.

The processing of the multimedia data may include: decoding a transform coefficient of the multimedia data; and extracting a frequency component for extraction of image quality information from the decoded transform coefficient, and the transmitting of the multimedia data may include transmitting the extracted frequency component.

The processing of the multimedia data may include automatically transcoding the multimedia data based on device characteristics of the host, and the transmitting of the multimedia data may include transmitting the transcoded multimedia data.

The storing of the multimedia data may include: detecting a file type of the multimedia data; generating a probabilistic model automatically based on a result of the detection; selecting a compression mode based on the generated probabilistic model; compressing the multimedia data in the selected compression mode; and storing the compressed multimedia data.

The storing of the multimedia data may include: receiving the multimedia data from at least one of a mobile high-definition link (MHL) interface and a dummy terminal; transforming the received multimedia data into a real-time playable format; and storing the transformed multimedia data.

The storing of the multimedia data may include encoding the multimedia data based on a user input, and the receiving of the multimedia data request may include: receiving authentication information for authentication of an access right to the multimedia data; and performing an authentication process based on the authentication information.

The method may further include: determining at least one of an image quality of the stored multimedia data, rotation information of the stored multimedia data, and a period in which there is no access to the stored multimedia data; and performing at least one of hiding of the stored multimedia data, transform of the stored multimedia data, and transmission of the stored multimedia data to a cloud server, based on a result of the determination.

The method may further include: detecting duplicate multimedia data from the multimedia data stored in the storage device; and deleting the duplicate multimedia data but not other multimedia data or deleting only the duplicate multimedia data.

According to an exemplary embodiment, a storage device for distributed processing of multimedia data includes: a storage unit configured to store multimedia data; a control unit configured to process the multimedia data based on a multimedia data request received from a host; and an interface unit configured to receive the multimedia data request from the host and transmit the processed multimedia data to the host.

The interface unit may receive at least one of a command and a program executable in the storage device from the host, and the control unit may process the multimedia data based on at least one of the received command and the received program.

The control unit may detect and extract an intra frame from the multimedia data, and the interface unit may transmit the extracted intra frame.

The control unit may decode the multimedia data, detect a thumbnail frame from the decoded multimedia data, and generate a thumbnail, and the interface unit may transmit the generated thumbnail.

The control unit may extract a data descriptor from the multimedia data, and the interface unit may transmit the extracted data descriptor.

The control unit may decode a transform coefficient of the multimedia data and extract a frequency component for extraction of image quality information from the decoded transform coefficient, and the interface unit may transmit the extracted frequency component.

The control unit may transcode the multimedia data automatically based on device characteristics of the host, and the interface unit may transmit the transcoded multimedia data.

The storage unit may detect a file type of the multimedia data, generate a probabilistic model automatically based on a result of the detection, select a compression mode based on the generated probabilistic model, compress the multimedia data in the selected compression mode, and store the compressed multimedia data.

The storage unit may receive the multimedia data from at least one of a mobile high-definition link (MHL) interface and a dummy terminal, transform the received multimedia data into a real-time playable format, and store the transformed multimedia data.

The storage unit may encode the multimedia data based on a user input, and the interface unit may receive authentication information for authentication of an access right to the multimedia data and perform an authentication process based on the authentication information.

The control unit may determine at least one of an image quality of the stored multimedia data, rotation information of the stored multimedia data, and a period in which there is no access to the stored multimedia data, and perform at least one of hiding of the stored multimedia data, transforming of the stored multimedia data, and transmitting of the stored multimedia data to a cloud server, based on a result of the determination.

The control unit may detect duplicate multimedia data from the multimedia data stored in the storage device, and delete only the duplicate multimedia data but not other multimedia data.

According to an exemplary embodiment, a non-transitory computer-readable recording medium stores a program that, when executed by a computer, performs the above method.

### BRIEF DESCRIPTION OF THE DRAWINGS

These and/or other aspects will become apparent and more readily appreciated from the following description of the embodiments, taken in conjunction with the accompanying drawings in which:

FIG. 1 is a conceptual diagram of a system for processing multimedia data in a distributed manner, according to an exemplary embodiment;

FIG. 2 is a flowchart of a method of processing multimedia data in a storage device in a distributed manner, according to an exemplary embodiment;

FIG. 3 is a flow diagram of a method of processing multimedia data in a distributed manner, according to an exemplary embodiment;

FIG. 4 is a flowchart of a process of storing multimedia data, according to an exemplary embodiment;

FIG. 5 is a flowchart of a process of receiving a multimedia data request, for multimedia data security, according to an exemplary embodiment;

FIG. 6 is a conceptual diagram of a system where the storage device is used as an independent computing platform, according to an exemplary embodiment;

FIG. 7 is a conceptual diagram of a system where the storage device is used as a cloud client, according to an exemplary embodiment; and

FIG. 8 is a block diagram of the storage device for processing multimedia data in a distributed manner, according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are described below, by referring to the figures, to explain aspects of the present description. As used herein, expressions such as “at least one of,” when preceding a list of elements, modify the entire list of elements and do not modify the individual elements of the list.

The effects and features of the exemplary embodiments and the accomplishing method thereof will become apparent from the following description of the embodiments, taken in conjunction with the accompanying drawings. The inventive concept may, however, be embodied in many different forms and should not be construed as being limited to the exemplary embodiments set forth herein; rather, these exemplary embodiments are provided so that this disclosure will be thorough and complete, and will fully convey the inventive concept to those of ordinary skill in the art. Therefore, the scope of the inventive concept is defined not by the detailed description of the inventive concept but by the appended claims.

Terms used herein will be described in brief prior to a detailed description of the exemplary embodiments.

While widely-used general terms are selected and used herein in consideration of functions in the inventive concept, these terms may vary according to the intentions of those skilled in the art, the precedents, or the appearance of new technology. Also, in some cases, there may be terms that are optionally selected by the applicant, and the meanings thereof will be described in detail in the corresponding portions of the description of the exemplary embodiments. Therefore, the terms used herein are not simple terms and should be defined based on the meanings thereof and the overall description of the exemplary embodiments.

It will be understood that when an element is referred to as being “connected” to another element, it may be directly connected to the other element or may be electrically connected to the other element with other element(s) interposed therebetween. It will be understood that the terms “comprise”, “include”, and “have”, when used herein, specify the presence of stated elements, but do not preclude the presence or addition of other elements, unless otherwise specified.

The term “unit” used herein refers to software or hardware such as Field Programmable Gate Array (FPGA) or Application Specific Integrated Circuit (ASIC), and the “unit” performs some functions. However, the “unit” is not limited to software or hardware. The “unit” may be configured to exist in an addressable storage medium, or may be configured to reproduce one or more processors. Therefore, as an example, “units” may include various elements such as software elements, object-oriented software elements, class elements, and task elements, processes, functions, attributes, procedures, subroutines, program code segments, drivers, firmware, microcodes, circuits, data, databases, data structures, tables, arrays, and variables. Functions provided in “units” and elements may be combined into a smaller number of “units” and elements, or may be divided into additional “units” or elements.

In this specification, “multimedia data” use multimedia elements such as characters, pictures, and sounds, and are digitally converted and provided to users. The “multimedia data” may be data including at least one of texts, images, sounds, animations, and moving images, but are not limited thereto.

In this specification, a “host” may be a digital electronic product such as a personal computer (PC), a digital TV, or a digital camcorder, to which a nonvolatile memory is connected, but is not limited thereto.

Exemplary embodiments will be described below in detail with reference to the accompanying drawings so that those of ordinary skill in the art may easily implement the exemplary embodiments. The inventive concept may, however, be embodied in many different forms and should not be construed as being limited to the exemplary embodiments set forth herein. Also, portions not necessary to explain the description of the exemplary embodiments will be omitted in the drawings for a clear description of the exemplary embodiments, and like reference numerals denote like elements throughout the specification.

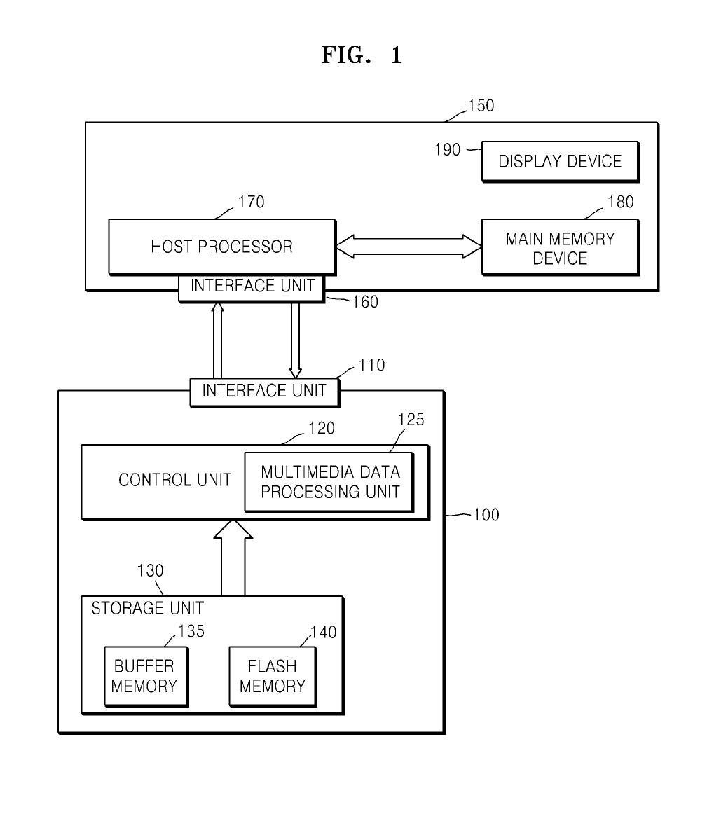

FIG. 1 is a conceptual diagram of a system for processing multimedia data in a distributed manner, according to an exemplary embodiment.

A storage device according to an exemplary embodiment refers to a storage device for storing programs or data outside a central processing unit (CPU), but not a CPU of a computer. The storage device according to an exemplary embodiment may be implemented in various forms.

The storage device described herein may be, for example, an auxiliary memory device such as a floppy disk, a hard disk drive (HDD), a solid state drive (SSD), a magnetic drum, a magnetic tape, an optical disk (e.g., a compact disk (CD)), or a flash memory, but is not limited thereto.

As illustrated in FIG. 1, a storage device 100 according to an exemplary embodiment may include an interface unit 110 (e.g., an interface), a control unit 120 (e.g., a controller), and a storage unit 130 (e.g., a storage). A host 150 according to an exemplary embodiment may include an interface unit 160, a host processor 170, a main memory device 180, and a display device 190. However, not all of the illustrated elements are indispensable elements. The system may include more elements than the illustrated elements, or may include fewer elements than the illustrated elements.

The interface units 110 and 160 are interfaces that are connected to enable an interaction between two systems or between hardware and software that constitute one system. The storage device 100 and the host 150 may share multimedia data through the interface units 110 and 160. The host 150 may transmit a multimedia data request to the storage device 100 through the interface unit 160. The storage device 100 may transmit multimedia data to the host 150 through the interface unit 110.

Based on the multimedia data request of the host 150, the control unit 120 may detect multimedia data stored in the storage unit 130 and transmit the multimedia data to the host 150. According to an exemplary embodiment, the control unit 120 may include a multimedia data processing unit 125 (e.g., a multimedia processor) that may process multimedia data based on the multimedia data request of the host 150. According to an exemplary embodiment, the control unit 120 may manage the stored multimedia data.

The storage unit 130 stores multimedia data. According to an exemplary embodiment, the storage unit 130 may include a flash memory 140 and a buffer memory 135. The flash memory 140 is a nonvolatile memory that may retain stored data even when power supply thereto is interrupted. The multimedia data may be stored in the flash memory 140. The buffer memory 135 is a high-speed memory device that is used to temporarily store data and commands that are exchanged between the storage device 100 and the host 150. The buffer memory 135 may settle a transmission speed difference between the storage device 100 and the host 150.

The host processor 170 processes multimedia data. According to an exemplary embodiment, the host processor 170 may transmit a multimedia data request to the storage device 100, and may receive the processed multimedia data from the storage device 100 and transmit the received multimedia data to the main memory device 180.

The main memory device 180 is a memory device whose data may be processed directly by a CPU. The main memory device 180 may include read-only memory (ROM) that may retain stored data even when powered off, and a volatile memory type random-access memory (RAM) that loses stored data when powered off. According to an exemplary embodiment, the main memory device 180 may receive the processed multimedia data from the storage device 100 through the interface unit 160.

The display device 190 displays the processed multimedia data. According to an exemplary embodiment, the display device 190 may display the processed multimedia data received from the storage device 100 in real time.

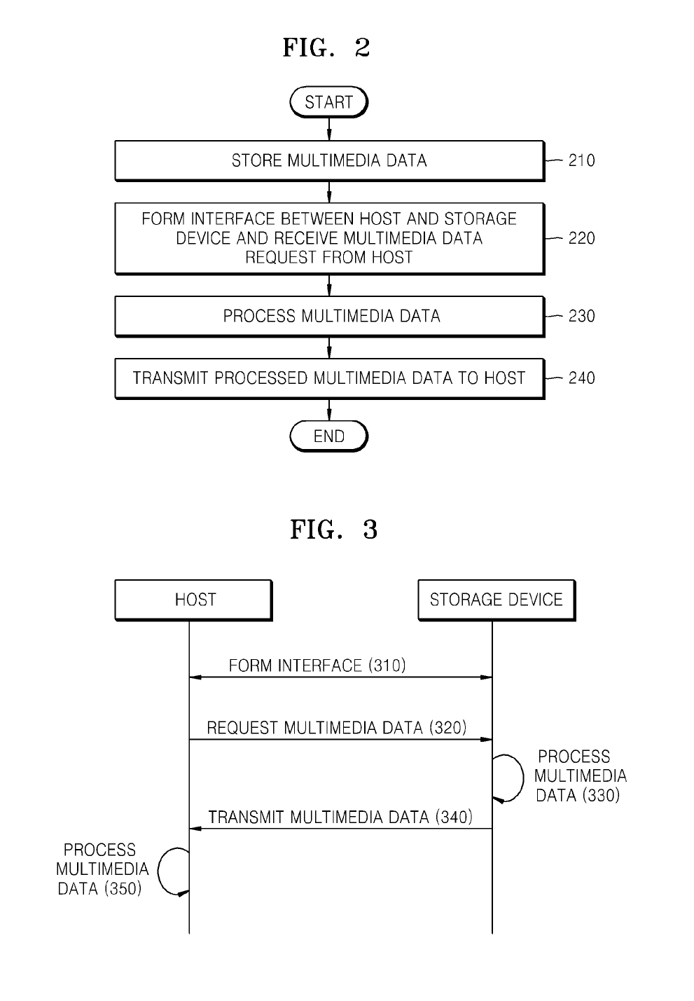

FIG. 2 is a flowchart of a method of processing multimedia data in the storage device 100 in a distributed manner, according to an exemplary embodiment.

In operation 210, the storage device 100 stores multimedia data.

The storage device 100 may receive multimedia data from the host 150 and a separate terminal device and store the received multimedia data. The terminal device described herein may include mobile phones, smartphones, notebook computers, digital broadcast terminals, personal digital assistants (PDAs), portable multimedia players (PMPs), or dummy terminals, but is not limited thereto.

According to an exemplary embodiment, the storage device 100 may compress data such as uncompressed raw files and then store the compressed data.

According to an exemplary embodiment, the storage device 100 may receive the multimedia data together with a compression algorithm. The compression algorithm may include, for example, run-length coding, Huffman coding, Lempel-Ziv coding, transform coding, predictive coding, quantization, wavelet-based coding, interpolation, fractal compression, an image compression technique such as Joint Photographic Experts Group (JPEG) or Graphic Interface Format (GIF), an audio and video compression technique such as Moving Picture Experts Group (MPEG), and a video compression technique such as H.261 or H.263, but is not limited thereto. The storage device 100 may compress and store multimedia data that is received by a receiving algorithm.

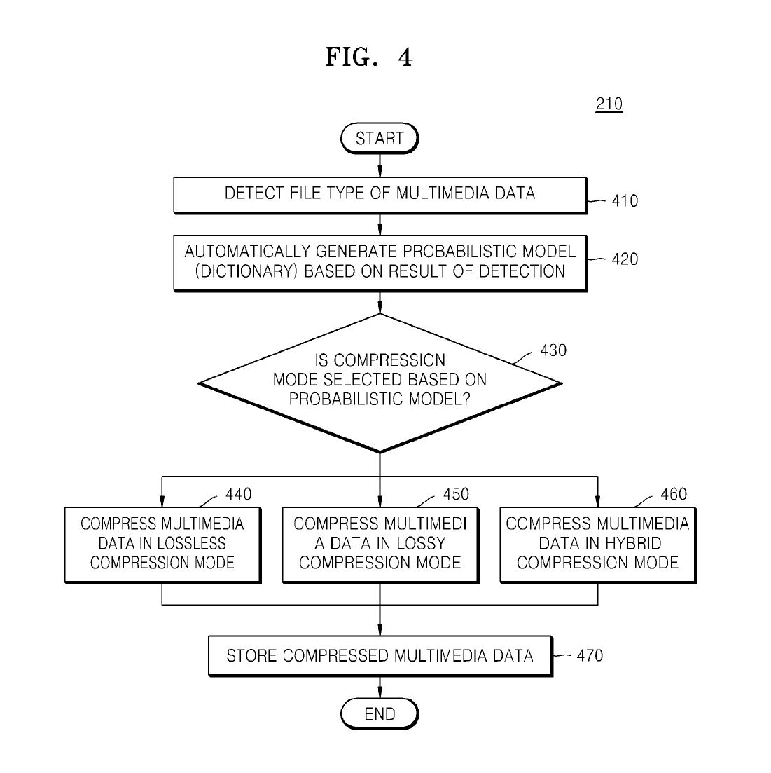

According to another exemplary embodiment, the storage device 100 may select a compression mode suitable for a file type of the received multimedia data and compress the received multimedia data in the selected compression mode. This will be described later in detail with reference to FIG. 4.

According to an exemplary embodiment, for multimedia data security, the storage device 100 may allow access to only a user who is authenticated for an access right. For multimedia data security, the storage device 100 may encode the multimedia data when storing the multimedia data. For example, the storage device 100 may receive a code for authenticating an access right based on a user input together with the multimedia data, and store the received multimedia data and the received code.

According to an exemplary embodiment, the code for authenticating an access right may be given as a password. For example, a first password may be applied to a portion of the multimedia data disclosed to a first user, and a second password may be applied to a portion of the multimedia data disclosed to a second user.

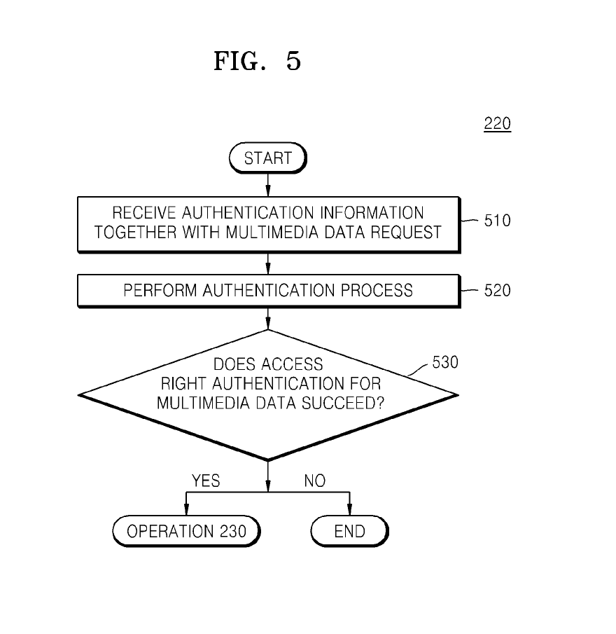

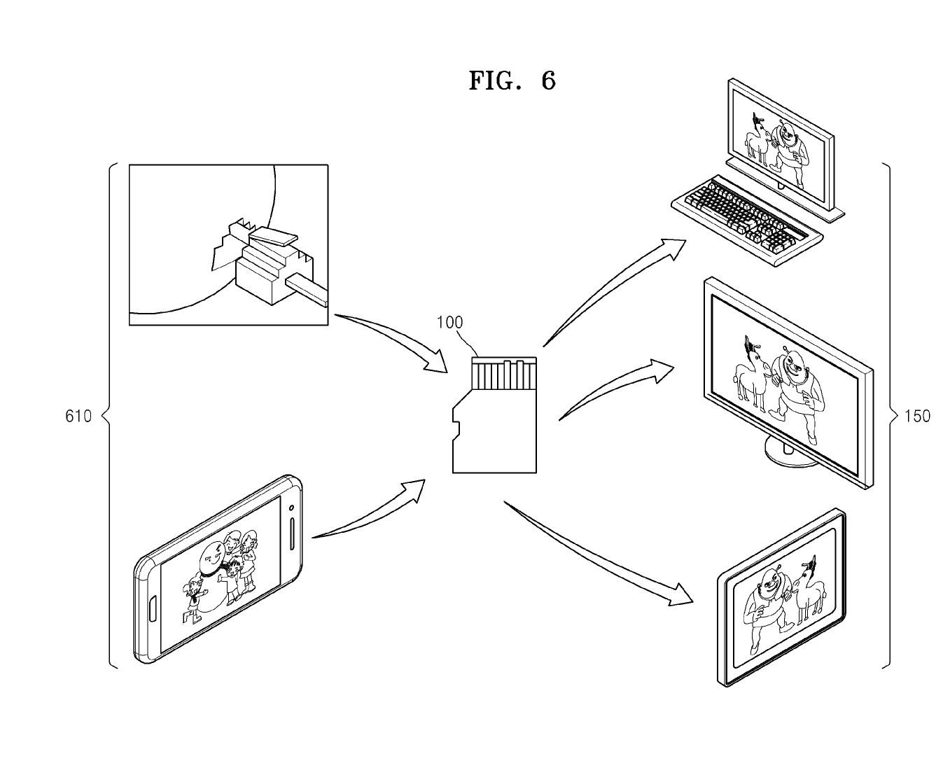

A method for multimedia data security will be described later in detail with reference to FIG. 5.

In operation 220, the storage device 100 forms an interface between the host 150 and the storage device 100 and receives a multimedia data request from the host 150.

In this specification, the interface may mean both hardware and software. The storage device 100 may share multimedia data with the host 150 through the interface.

The multimedia data request may include a request for data obtained by decoding the multimedia data stored in the storage device 100, a request for data obtained by transforming the multimedia data stored in the storage device according to the characteristics of a host device, a request for an intra frame of the multimedia data stored in the storage device 100, a request for a thumbnail of the multimedia data stored in the storage device 100, a request for a summary of the multimedia data stored in the storage device 100, a request for a descriptor of the multimedia data stored in the storage device 100, and a request for a frequency component of the multimedia data stored in the storage device 100, but is not limited thereto.

The multimedia data request may be received by the storage device 100 from the host 150 in the form of at least one of a command and a program executable in the storage device 100. Unlike a program command, the command is a signal for providing an instruction directly from the host 150 to the storage device 100.

According to an exemplary embodiment, the host 150 may program an operation that is to be performed by the control unit 120 of the storage device 100.

In operation 230, the storage device 100 processes the multimedia data based on the received multimedia data request.

The storage device 100 may process the multimedia data based on at least one of the received command and the received program.

According to an exemplary embodiment, based on the received multimedia data request, the storage device 100 may detect and extract only an intra frame of the stored multimedia data. The intra frame may be used to implement a fast forward function, a rewind function, and a random play function. For example, the storage device 100 may decode the encoded and stored multimedia data and extract an intra frame of the decoded multimedia data.

According to an exemplary embodiment, based on the received multimedia data request, the storage device 100 may transform the stored multimedia data according to the characteristics of a host device. For example, the storage device 100 may transform the multimedia data into a format, a resource, and a profile suitable for the characteristics of a host device.

According to an exemplary embodiment, the storage device 100 may generate a thumbnail of the stored multimedia data based on the received multimedia data request. For example, the storage device 100 may decode the stored multimedia data, extract a thumbnail frame among frames of the decoded multimedia data, and generate a thumbnail based on the detected thumbnail frame.

According to an exemplary embodiment, the storage device 100 may generate a summary of the stored multimedia data based on the received multimedia data request. For example, the storage device 100 may decode the stored multimedia data and generate a summary thereof based on a feature value of the decoded multimedia data.

According to an exemplary embodiment, the storage device 100 may extract a descriptor of the stored multimedia data based on the received multimedia data request. For example, the storage device 100 may extract a descriptor for efficiently detecting and managing the multimedia data, by using at least one of physical information that may be obtained from a file header and inherent information that is obtained by analyzing the multimedia data.

According to an exemplary embodiment, the storage device 100 may extract a frequency component of the stored multimedia data based on the received multimedia data request. For example, the storage device 100 may decode a transform coefficient of the multimedia data and extract a frequency component for image quality information extraction from the decoded transform coefficient.

According to an exemplary embodiment, the storage device 100 may perform post-processing according to a low light shot based on the received multimedia data request.

According to an exemplary embodiment, the storage device 100 may perform encoding or decoding in parallel with the host processor 170 based on the received multimedia request.

According to an exemplary embodiment, when the host 150 stores the multimedia data, processes the multimedia data in real time, or displays the multimedia data in real time, the host 150 may perform a multimedia data processing operation in a distributed manner in parallel with the storage device 100. Therefore, a processing load in the host 150 may be reduced, and real-time data processing of multimedia data may be improved. Also, since the storage device 100 performs simple operations such as intra data extraction, data decoding, and data transform, it may be possible to prevent power consumption that may be caused by an unnecessary CPU operation when a host CPU accesses and processes all data.

In operation 240, the storage device 100 transmits the processed multimedia data to the host 150 through the interface.

According to an exemplary embodiment, the processed multimedia data may include data obtained by decoding the multimedia data, data obtained by transforming the multimedia data according to the characteristics of a host device, an intra frame of the multimedia data, a thumbnail of the multimedia data, a summary of the multimedia data, a descriptor of the multimedia data, and a frequency component of the multimedia data, but is not limited thereto.

According to an exemplary embodiment, when the host 150 needs only a portion of the multimedia data, the storage device 100 may extract only necessary data or may process the data into a necessary data format and transmit the processed data to the host 150. Therefore, a data transmission load may be reduced, and thus a data transmission time and power consumption caused by unnecessary data transmission may be reduced. Also, it may be possible to prevent performance degradation that may be caused when a large amount of data is all transmitted to the host 150.

FIG. 3 is a flow diagram of a method of processing multimedia data in a distributed manner, according to an exemplary embodiment.

In operation 310, when the storage device 100 is connected to the host 150, an interface is formed between the host 150 and the storage device 100.

In operation 320, the host 150 requests multimedia data from the storage device 100.

The host 150 may transmit a multimedia data request to the storage device 100 in the form of at least one of a command and a program executable in the storage device 100.

According to an exemplary embodiment, the multimedia data request includes a request for transmission of the multimedia data stored in the storage device 100, and may include a request for data obtained by decoding the multimedia data stored in the storage device 100, a request for data obtained by transforming the multimedia data stored in the storage device 100 according to the characteristics of a host device, a request for an intra frame of the multimedia data stored in the storage device 100, a request for a thumbnail of the multimedia data stored in the storage device 100, a request for a summary of the multimedia data stored in the storage device 100, a request for a descriptor of the multimedia data stored in the storage device 100, and a request for a frequency component of the multimedia data stored in the storage device 100, but is not limited thereto.

In operation 330, the storage device 100 processes the multimedia data based on the multimedia data request received from the host 150.

According to an exemplary embodiment, the processing of the multimedia data may include decoding the multimedia data, transforming the multimedia data according to the characteristics of a host device, extracting an intra frame of the multimedia data, generating a thumbnail of the multimedia data, generating a summary of the multimedia data, extracting a descriptor of the multimedia data, and extracting a frequency component of the multimedia data, but is not limited thereto.

In operation 340, the storage device 100 may transmit the processed multimedia data to the host 150.

In operation 350, the host 150 may process the multimedia data received from the storage device 100.

According to an exemplary embodiment, the host processor 170 may transmit the received multimedia data to the main memory device 180.

According to an exemplary embodiment, the host 150 may display the multimedia data received from the storage device 100, immediately without additional processing.

FIG. 4 is a flowchart of a process of storing multimedia data, according to an exemplary embodiment.

According to an exemplary embodiment, in the operation of receiving and storing the multimedia data, the storage device 100 may automatically select a compression mode, compress the multimedia data in the selected compression mode, and store the compressed multimedia data.

In operation 410, the storage device 100 detects a file type of the multimedia data.

In operation 420, the storage device 100 may automatically generate a probabilistic model (dictionary) based on a result of the detection.

For example, the storage device 100 may select a mode using a single model or a mode using a plurality of probabilistic models.

In operation 430, the storage device 100 may select a compression mode for increasing compression efficiency, based on the generated probabilistic model.

According to an exemplary embodiment, the storage device 100 may select a compression mode in consideration of not only compression efficiency but also an application of the multimedia data.

According to an exemplary embodiment, the compression mode may include a lossy compression mode, a lossless compression mode, and a hybrid compression mode, but is not limited thereto.

In operation 440, when a lossless compression mode is selected, the storage device 100 may compress the multimedia data in the lossless compression mode.

The lossless compression mode losslessly encodes all information included in the uncompressed data, and removes only duplication that may be caused by the repeated occurrence of the same information. The lossless compression mode may include, for example, run-length coding, Huffman coding, and Lempel-Ziv coding, but is not limited thereto.

In operation 450, when a lossy compression mode is selected, the storage device 100 may compress the multimedia data in the lossy compression mode.

The lossy compression mode deletes information, which does not significantly affect content recognition, among the information included in data. The lossy compression mode may include, for example, transform coding, predictive coding, quantization, wavelet-based coding, interpolation, and fractal compression, but is not limited thereto.

In operation 460, when a hybrid compression mode is selected, the storage device 100 may compress the multimedia data in the hybrid compression mode.

The hybrid compression mode is a hybrid of the lossy compression mode and the lossless compression mode, and is used in most standard compression techniques. The hybrid compression mode may include, for example, an image compression technique such as JPEG or GIF, an audio and video compression technique such as MPEG, and a video compression technique such as H.261 or H.263, but is not limited thereto.

In operation 470, the storage device 100 may store the compressed multimedia data.

According to an exemplary embodiment, when the storage device 100 is an SSD, the multimedia data may be stored in RAM or a flash memory.

FIG. 5 is a flowchart of a process of receiving a multimedia data request, for multimedia data security, according to an exemplary embodiment.

According to an exemplary embodiment, for multimedia data security, the storage device 100 may allow access to only a user who is authenticated for an access right. For multimedia data security, the storage device 100 may encode the multimedia data when storing the multimedia data.

In operation 510, the storage device 100 receives authentication information together with a multimedia data request from the host 150.

The authentication information is used to authenticate an access right to the multimedia data. According to an exemplary embodiment, the authentication information may include a watermark or a password based on a user input, but is not limited thereto.

In operation 520, the storage device 100 performs an authentication process based on the authentication information.

For example, when the authentication information is a password, the storage device 100 may determine whether codes set in the password and the multimedia data are identical to each other.

In operation 530, the storage device 100 determines whether access right authentication for the multimedia data has succeeded.

If the access right authentication has succeeded, operation 230 is performed.

Otherwise, if the access right authentication has failed, the process is ended. According to an exemplary embodiment, if the access right authentication has failed, the storage device 100 may automatically delete the multimedia data.

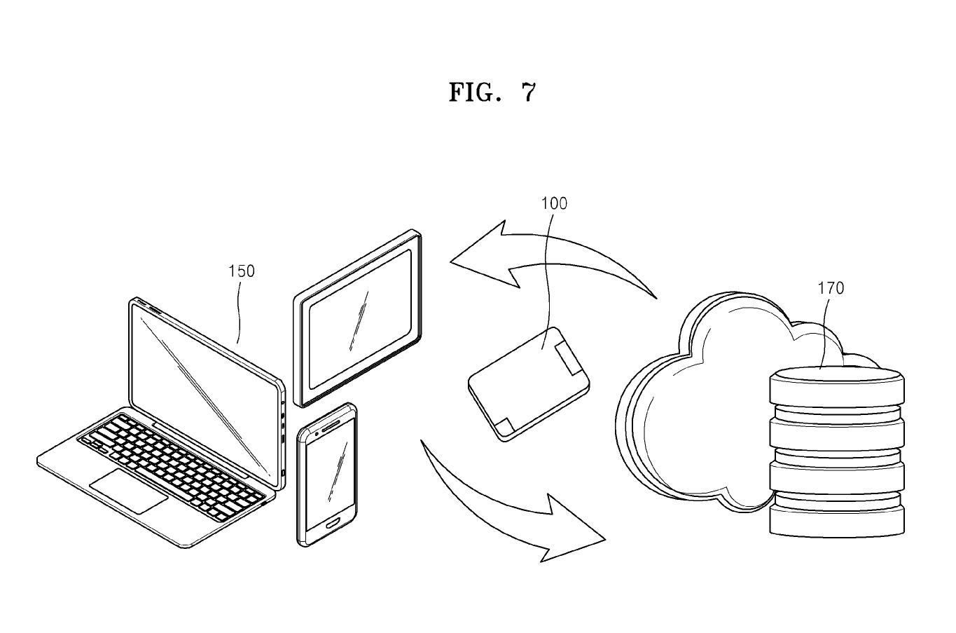

FIG. 6 is a conceptual diagram of a system in which the storage device 100 is used as an independent computing platform, according to an exemplary embodiment.

The system may include a first terminal 610, a storage device 100, and a host 150. The first terminal 610 may include a mobile terminal, a PMP, a PDA, and a dummy terminal, but is not limited thereto.

According to an exemplary embodiment, the storage device 100 may receive multimedia data from at least one of a mobile high-definition link (MHL) interface and a dummy terminal and store the received multimedia data. MHL is a technology that transfers a screen of a mobile device such as a smartphone to a large display at high image quality, and it may also supply power. The dummy terminal refers to a terminal that inputs/outputs data without processing the data.

According to an exemplary embodiment, the storage device 100 may transform the multimedia data into a real-time playable format when storing the multimedia data. For example, when multimedia data of an MPEG format stored in the first terminal 610 is transmitted to the host 150 supporting only an audio video interleave (AVI) format, the storage device 100 may convert the MPEG format into the AVI format. Therefore, the host 150 may immediately use the multimedia data in a display even without directly converting a multimedia file.

The transformed multimedia data may be transmitted to the host 150 and displayed on the display device 190 of the host 150 in real time. According to an exemplary embodiment, the storage device 100 may perform an authentication process for multimedia data security before transmitting the multimedia data.

According to an exemplary embodiment, the storage device 100 may perform multimedia data editing and decoding by being connected to the dummy terminal in a certain environment.

FIG. 7 is a conceptual diagram of a system in which the storage device 100 is used as a cloud client, according to an exemplary embodiment.

The system may include a host 150, a storage device 100, and a cloud server 710.

According to an exemplary embodiment, the storage device 100 may store multimedia data in the cloud server 710. Also, the storage device 100 may receive multimedia data stored in the cloud server 710 and transmit the received multimedia data to the host 150. For example, an SSD that is the storage device 100 may be used as a local cache of the cloud.

According to an exemplary embodiment, the storage device 100 may encode the multimedia data for multimedia data security before transmitting the multimedia data to the cloud server 710.

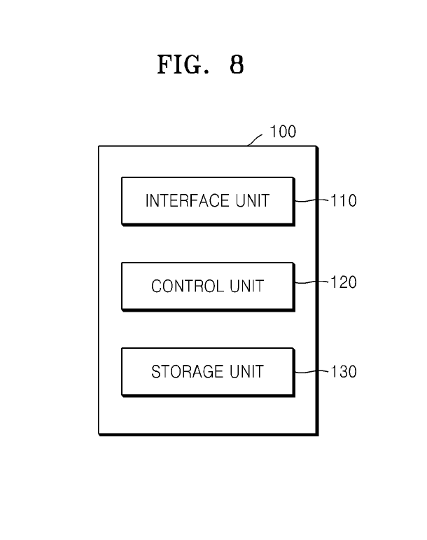

FIG. 8 is a block diagram of a storage device 100 for processing multimedia data in a distributed manner according to an exemplary embodiment.

The storage device 100 may include an interface unit 110, a control unit 120, and a storage unit 130.

The above components will be described below.

The interface unit 110 is an interface that is connected to enable an interaction between two systems or between hardware and software that constitute one system. The storage device 100 may share multimedia data with the host 150 through the interface unit 110. The storage device 100 may receive a multimedia data request from the host 150 through the interface unit 110. The multimedia data request may be received by the storage device 100 from the host 150 in the form of at least one of a command and a program executable in the storage device 100. The storage device 100 may transmit multimedia data to the host 150 through the interface unit 110.

Based on the multimedia data request of the host 150, the control unit 120 may detect multimedia data stored in the storage unit 130 and transmit the multimedia data to the host 150. Also, the control unit 120 may process the multimedia data based on the multimedia data request received from the host 150.

According to an exemplary embodiment, the processing of the multimedia data may include decoding the multimedia data, transforming the multimedia data according to the characteristics of a host device, extracting an intra frame of the multimedia data, generating a thumbnail of the multimedia data, generating a summary of the multimedia data, extracting a descriptor of the multimedia data, and extracting a frequency component of the multimedia data, but is not limited thereto.

According to an exemplary embodiment, the control unit 120 may manage the multimedia data stored in the storage unit 130.

According to an exemplary embodiment, the control unit 120 determines an image quality of the multimedia data stored in the storage unit 130. For example, the control unit 120 may determine whether a low-quality image or a blur image is meaningless to a user, and hide a meaningless image.

According to an exemplary embodiment, the control unit 120 may determine a degree of image rotation based on rotation information of the multimedia data stored in the storage unit 130, and rotate a rotated image to a normal angle.

According to an exemplary embodiment, the control unit 120 may transmit the multimedia data to the cloud server 710 when a period in which there is no access to the multimedia data stored in the storage unit 130 is more than a predetermined period. The control unit 120 may also perform processing for multimedia data security when transmitting the multimedia data to the cloud server 710. For example, the control unit 120 may encode the multimedia data for multimedia data security and transmit the encoded multimedia data to the cloud server 710. The control unit 120 may delete the multimedia data after transmitting the multimedia data to the cloud server 710.

According to an exemplary embodiment, the control unit 120 may determine whether the multimedia data stored in the storage unit 130 is a duplicate, and delete the duplicate data but not the other multimedia data.

The storage unit 130 stores the multimedia data. The storage unit 130 may receive multimedia data from the host 150 and a separate terminal device and store the received multimedia data.

According to an exemplary embodiment, the storage unit 130 may compress data such as uncompressed raw files and then store the compressed data.

According to an exemplary embodiment, for multimedia data security, the storage unit 130 may encode the multimedia data when storing the multimedia data. For example, the storage unit 130 may store a code for authenticating an access right, together with the multimedia data.

The exemplary embodiments may also be implemented in the form of a computer-readable recording medium including instructions executable by a computer, such as a program module executed by a computer. The computer-readable recording medium may be any available medium accessible by computers, examples of which may include a volatile recording medium, a nonvolatile recording medium, a removable recording medium, and an unremovable recording medium. Examples of the computer-readable recording medium may also include a computer storage medium and a communication medium. Examples of the computer storage medium may include a volatile storage medium, a nonvolatile storage medium, a removable storage medium, and an unremovable storage medium that are implemented by any method or technology for storing information such as computer-readable instructions, data structures, program modules, or other data. Examples of the communication medium may include any information transmission medium including computer-readable instructions, data structures, program modules, other data of modulated data signals, or other transmission mechanisms.

The foregoing is illustrative of exemplary embodiments and is not to be construed as limiting thereof. Although the exemplary embodiments have been described above, those of ordinary skill in the art will readily appreciate that various modifications are possible in the exemplary embodiments without materially departing from the concepts and features of the exemplary embodiments. Therefore, it is to be understood that the exemplary embodiment described above should be considered in descriptive sense only and not for purposes of limitation. For example, elements described as being combined may also be implemented in a distributed manner, and elements described as being distributed may also be implemented in a combined manner.

It should be understood that the exemplary embodiments described herein should be considered in a descriptive sense only and not for purposes of limitation. Descriptions of features or aspects within each embodiment should typically be considered as available for other similar features or aspects in other embodiments.

While exemplary embodiments have been described with reference to the figures, it will be understood by those of ordinary skill in the art that various changes in form and details may be made therein without departing from the spirit and scope of the inventive concept as defined by the following claims.

What is claimed is:

1. A method of distributed processing of multimedia data in a storage device, the method comprising:
storing multimedia data;
initiating an interface configured to share data between a host and the storage device;
receiving a multimedia data request from the host;
processing, by the storage device, the multimedia data based on the received multimedia data request; and
transmitting the processed multimedia data from the storage device to the host through the interface.

2. The method of claim 1, wherein the receiving the multimedia data request comprises receiving at least one of a command and a program executable in the storage device from the host, and
wherein the processing the multimedia data comprises processing the multimedia data based on at least one of the received command and the received program.

3. The method of claim 1, wherein the processing the multimedia data comprises detecting and extracting an intra frame from the multimedia data, and
wherein the transmitting the multimedia data comprises transmitting the extracted intra frame.

4. The method of claim 1, wherein the processing the multimedia data comprises:
decoding the multimedia data; and
detecting a thumbnail frame from the decoded multimedia data and generating a thumbnail, and
wherein the transmitting the multimedia data comprises transmitting the generated thumbnail.

5. The method of claim 1, wherein the processing the multimedia data comprises extracting a data descriptor from the multimedia data, and
wherein the transmitting the multimedia data comprises transmitting the extracted data descriptor.

6. The method of claim 1, wherein the processing the multimedia data comprises:
decoding a transform coefficient of the multimedia data; and
extracting a frequency component for extraction of image quality information from the decoded transform coefficient, and
wherein the transmitting the multimedia data comprises transmitting the extracted frequency component.

7. The method of claim 1, wherein the processing the multimedia data comprises automatically transcoding the multimedia data based on device characteristics of the host, and
wherein the transmitting the multimedia data comprises transmitting the transcoded multimedia data.

8. The method of claim 1, wherein the storing the multimedia data comprises:
detecting a file type of the multimedia data;
automatically generating a probabilistic model based on a result of the detection;
selecting a compression mode based on the generated probabilistic model;
compressing the multimedia data based on the selected compression mode; and
storing the compressed multimedia data.

9. The method of claim 1, wherein the storing the multimedia data comprises:
receiving the multimedia data from at least one of a mobile high-definition link (MHL) interface and a dummy terminal;
transforming the received multimedia data into a real-time playable format; and
storing the transformed multimedia data.

10. The method of claim 1, wherein the storing the multimedia data comprises encoding the multimedia data based on a user input, and
wherein the receiving the multimedia data request comprises:
receiving authentication information for authentication of an access right to the multimedia data; and
performing an authentication process based on the authentication information.

11. The method of claim 1, further comprising:
determining at least one of an image quality of the stored multimedia data, rotation information of the stored multimedia data, and a period in which there is no access to the stored multimedia data; and
performing at least one of hiding of the stored multimedia data, transforming of the stored multimedia data, and transmitting of the stored multimedia data to a cloud server, based on a result of the determination.

12. The method of claim 1, further comprising:
detecting duplicate multimedia data from the multimedia data stored in the storage device; and
deleting the duplicate multimedia data but not other multimedia data.

13. A storage device for distributed processing of multimedia data, the storage device comprising:
a storage configured to store multimedia data;
a controller configured to process the multimedia data based on a multimedia data request received from a host; and
an interface configured to receive the multimedia data request from the host and transmit the processed multimedia data to the host.

14. The storage device of claim 13, wherein
the interface receives at least one of a command and a program executable in the storage device from the host, and
wherein the controller processes the multimedia data based on at least one of the received command and the received program.

15. The storage device of claim 13, wherein
the controller detects and extracts an intra frame from the multimedia data, and
wherein the interface transmits the extracted intra frame.

16. The storage device of claim 13, wherein
the controller decodes the multimedia data, detects a thumbnail frame from the decoded multimedia data, and generates a thumbnail, and
wherein the interface transmits the generated thumbnail.

17. The storage device of claim 13, wherein
the controller decodes a transform coefficient of the multimedia data and extracts a frequency component for extraction of image quality information from the decoded transform coefficient, and
wherein the interface transmits the extracted frequency component.

18. The storage device of claim 13, wherein
the controller automatically transcodes the multimedia data based on device characteristics of the host, and
wherein the interface transmits the transcoded multimedia data.

19. The storage device of claim 13, wherein
the storage encodes the multimedia data based on a user input, and
wherein the interface receives authentication information for authentication of an access right to the multimedia data and performs an authentication process based on the authentication information.

20. A non-transitory computer-readable recording medium comprising computer executable instructions that, when executed by a computer, perform the method of claim 1.
